(19) United States
(12) Patent Application Publication
(10) Pub. No.: US 2012/0110469 A1
(43) Pub. Date: May 3, 2012

(54) Systems and Methods for Cross Domain Personalization

(76) Inventor: Gregory Magarshak, Brooklyn, NY (US)

(21) Appl. No.: 13/284,901

(22) Filed: Oct. 29, 2011

Related U.S. Application Data
(60) Provisional application No. 61/456,079, filed on Nov. 1, 2010.
(60) Provisional application No. 61/552,265, filed on Oct. 27, 2011.

(51) Int. Cl. G06F 3/01; G06F 21/00; H04L 9/32

(52) U.S. Cl. 715/747; 726/7

(57) ABSTRACT

The present invention relates to systems and methods for anonymously personalizing web content to a particular user. The methods and systems may include listening for requests including code and tags that stand for personalized information. Once a request is identified, the personal information for the user corresponding to the tags of the request may be masked by generating anonymized personalization elements. These anonymized personalization elements are elements in a web browser which are enabled to display the personal information from a different domain without allowing front-end scripting on the containing document to get access to the personal information. The anonymized personalization elements may be an iframe, in some embodiments. Lastly, an output, including the anonymized personalization elements, is returned.

### CROSS REFERENCE TO RELATED APPLICATIONS

This application claims priority to U.S. Provisional Application Ser. No. 61/552,265 filed on Oct. 27, 2011, entitled “Mechanism for enabling public and private streams on websites, which allow subscriptions that don't rely on centralized services for data delivery and processing”, which is hereby fully incorporated by reference.

This application also claims priority to U.S. Provisional Application Ser. No. 61/456,079 filed on Nov. 1, 2010, entitled “Mechanism for securely displaying and embedding personalized information in documents on other domains, including a system for anonymous instant personalization upon arrival to those domains”, which is hereby fully incorporated by reference.

### BACKGROUND

This invention relates generally to systems and methods that allow publishers of websites on the internet, mobile phones, and other media, to embed and display personalized information for a user that is visiting their documents. The invention will make possible a more personal and relevant experience to a user, while at the same protecting that user's privacy.

Over the last decade, users have continually pushed for greater levels of personalization and “social” attributes. Technology has responded to this need by making the internet more personalized and “social” over the past 10 years. These days, users desire to see information that is personalized for them, and publishers would like to present information that has personal and social relevance. But at the same time, users are afraid to reveal their information to third parties for fear that publishers may know too much about them or misuse their information in some way. This generates user discontent and friction between the desire for personalization, and the desire for privacy.

Current web technology provides some limited solutions which address these concerns. These include accounts with websites, sanitized client-side javascript, widgets that run within sites, and software services, such as Facebook Connect, OAuth, and similar services. Each of these methods of generating personalized web-surfing while maintaining some degree of privacy will be discussed in more detail below.

For accounts on a website, a user signs up, gets an account, and a password. The user may then provide some level of customization to their account, and places some level of trust that the account is secure. One problem with account based systems currently is that every site has its own information and it cannot share it easily. A second problem is that the user is required to have different login credentials for every site, otherwise the website you have an account at can, in principle, impersonate you by “trying your password” on other sites. Managing multiple account passwords can be difficult for a user, and keeping track of “who knows what” can be daunting.

For systems that employ sanitizing client-side javascript, a site which the user uses a lot and has already provided a lot of information to, is configured to be able to host “applications” from other domains. The trusted site thus provides the HTML to show within the other domains, in a “canvas”. This is the approach taken by FBML, FBJS and Caja. Before showing this HTML, the site replaces special tags with personal info, such as <fb:name> with a user's name, as they should appear to the logged-in user. It will also sanitize client-side javascript so that the other domain website cannot get access to this information. While this approach is acceptable in principle, it has several problems as well. First of all, publishers like the New York Times need to create applications that run within the canvas of another website, rather than being able to personalize their own website. Secondly, the whole system is centralized; if the host site (e.g., Facebook) is down or cuts the New York Times off, for whatever reason, no one can use that New York Times application, let alone a personalized version. A smaller, but still significant problem is that developers need to write code in modified or crippled versions of javascript, therefore increasing work for the publishers just so they can deploy a more personalized version somewhere on some “social” site.

Next, widget utilization is an approach that has been taken by tons of widgets around the web, and most recently, Facebook's social plugins. The idea is that all the social information and activity is shown within an iframe, and in that space, one can see personalized and socially relevant information such as their favorite songs, or their friends' favorite songs. These approaches as currently employed do not work well across distributed domains, and therefore limits their utility.

Lastly, Facebook Connect, OAuth, and similar services are a relatively new solution to this personalization dilemma. Websites which implement them allow their visitors to “Authorize” the website to find out who they are, and grab personal data from their social network. However, these services still suffer from major drawbacks. For example, OAuth is still made for centralized services like Facebook or twitter, which are supposed to host the user's information, thus the user is forced to trust them in order to personalize the site they are visiting, and doesn't really “own” their own data. Secondly, OAuth requires users to reveal more information to publishers than may be desirable.

It is therefore apparent that an urgent need exists for systems and methods for greater personalization of the internet without a meaningful reduction in user privacy. Such systems and methods would address the desire for users to have a more personalized browsing experience, enables publishers to have “richer” websites thereby attracting more visitors, and simultaneously protecting user's privacy.

### SUMMARY

To achieve the foregoing and in accordance with the present invention, systems and methods for personalization of web content without sacrificing user privacy is provided. Such systems and methods provide a more enjoyable browsing experience for the user, without compromising the user's personal information.

In some embodiments, the method for anonymously personalizing web content to a particular user may be useful in association with a personalization system. The method may include listening for requests including code and tags that stand for personalized information. Once a request is identified, the personal information for the user corresponding to the tags of the request may be masked by generating anonymized personalization elements. These anonymized personalization elements are elements in a web browser which are enabled to display the personal information from a different domain without allowing front-end scripting on the containing document to get access to the personal information. The anonymized personalization elements may be an iframe, in some embodiments. Lastly, an output, including the anonymized personalization elements, is returned.

The anonymized personalization elements may be cached. In some embodiments, this caching includes storing the anonymized personalization elements on client side local storage. Then the anonymized personalization elements may be shown, and client side script may be executed to populate the anonymized personalization elements with information appropriate to them.

In some embodiments, the method may obtain the user's identity. Further, the user may have unique identifiers for each publisher. In some cases, the method may also include receiving post back information from the publishing server. The post back information is aggregated with other information, and the aggregated information is displayed to friends of the user based upon the user's privacy settings.

In other embodiments, the method may load a static script from a constant URL. The static script is configured to look for information on a local computer and discover compatible services that a user has authenticated with. Then a request for a webpage from a user agent is received, and the static script is supplied to the user agent. Feedback from the static script is received, and this feedback is used to identify the compatible service which is then authenticated with. After authentication, the document with the personalization tags is returned to the user agent, and an output is received that includes anonymized personalization elements.

Lastly, a method for logging a user into a system is provided in which a login screen is displayed to a user from a centralized login server. A username is received from the user, which is then matched to a corresponding personal server different from the centralized login server. Lastly the user is redirected to the personal server. The personal server may be the authentication system and/or the personalization system.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a logical block diagram of a system for increasing internet personalization, in accordance with some embodiments;

FIG. 2 is a logical block diagram of the service enhancement system, in accordance with some embodiments;

FIG. 3 is an example flow chart illustrating a method for allowing granular access to internet resources, in accordance with some embodiments;

FIG. 4 is an example flow chart illustrating a method for performing a signup of a user, in accordance with some embodiments;

FIG. 5 is an example flow chart illustrating a method for procuring an access token from a publisher, in accordance with some embodiments;

FIG. 6 is an example flow chart illustrating a method for utilizing the token to gain access to a resource, in accordance with some embodiments;

FIG. 7 is an example flow chart illustrating a method for personalizing a document while maintaining maximal privacy, in accordance with some embodiments;

FIG. 8 is an example flow chart illustrating a method for enhancing personalization via a post back system, in accordance with some embodiments;

FIG. 9 is an example screen shot illustration of a personalized document, in accordance with some embodiments;

FIG. 10 is an example screen shot illustration of an authorization screen, in accordance with some embodiments;

FIG. 11 is an example screen shot illustration of an identification screen, in accordance with some embodiments;

FIG. 12 is an example chronological process diagram for the signup process, in accordance with some embodiments;

FIG. 13 is an example chronological process diagram for user authentication, in accordance with some embodiments;

FIG. 14 is an example chronological process diagram for stream update notification, in accordance with some embodiments;

FIG. 15 is an example chronological process diagram for the resource access process, in accordance with some embodiments;

FIG. 16 is an example chronological process diagram for the anonymous personalization, in accordance with some embodiments; and

FIG. 17 is an example chronological process diagram for logging in a user, in accordance with some embodiments.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to systems and methods for allowing publishers of websites on the internet, mobile phones, and other media, to embed and display personalized information for a user that is visiting their documents. Embodiments of the systems and methods will make possible a more personal and relevant experience to a user, while at the same protecting that user's privacy, and, in some embodiments, without even revealing any personally identifiable information to the publisher at all.

Such a personalization system may function independently, or may be capable of working synergistically with systems that enable distributed authorization of data streams. These systems and methods enhance internet content by making it more relevant, both personally and socially to the viewer of that content, while ensuring their privacy.

This disclosure will be presented in a series of subsections for the sake on enhanced clarity. These subsections are not intended to in any way limit the scope of the present disclosure. For example, methods and systems described in one subsection may be applied equally to other subsections where applicable.

### I. System Overview

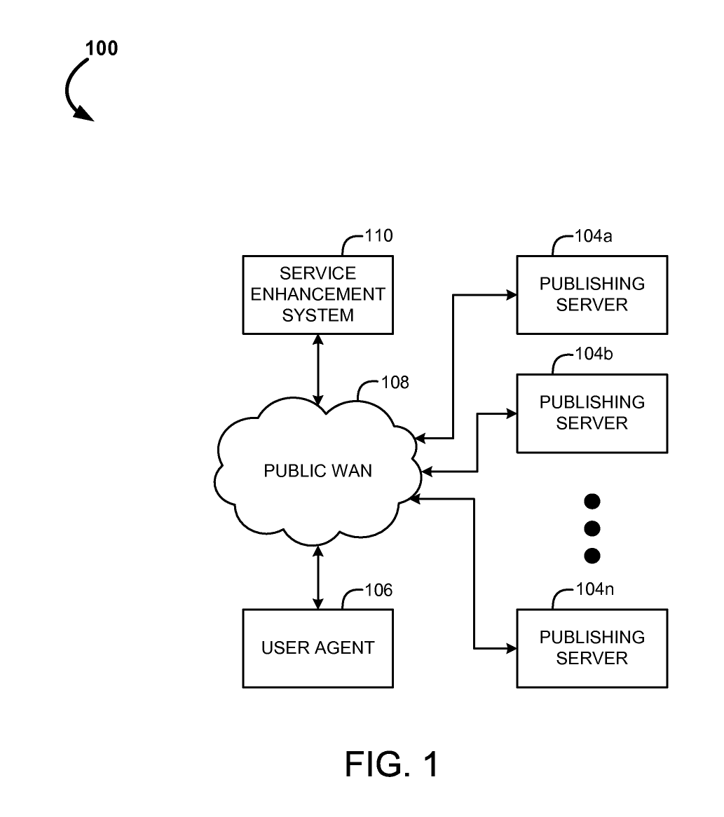

To facilitate discussion, FIG. 1 is a logical block diagram of a system for increasing internet personalization, shown generally at 100, in accordance with some embodiments. Embodiments illustrated here may include the ability for both granular resource access, and personalization. These methods and systems may be implemented independently, in some embodiments, or may be performed synergistically, in alternate embodiments. Additionally, in some embodiments, the system illustrated here may be altered to be enabled to perform only one functionality, or the other, as may be desired in some instances.

In this example block diagram, a number of systems are seen capable of communication and interaction over a public WAN (Wide Area Network) 108. The public WAN 108 often referred to in the context of this disclosure may be the internet, however other public networks are considered, such as ad hoc networks. However, for the sake of clarity, for the remainder of this application the internet 108 will be referenced in order to not unnecessarily clutter the disclosure.

A User Agent 106 may include a web browser (i.e., Internet Explorer or Firefox) running on a user's computer system. The User Agent 106 is utilized by the user to visit web servers over the internet 108, as is commonly known. For example, the User Agent 106 may communicate with one or more Publishing Servers 104a to 104n, which may publish information across any number of platforms. Examples of Publishing Servers 104a to 104n include Facebook or The New York Times. The Publishing Server 104a to 104n may also be able to publish data on a wide array of platforms, including computer systems, mobile phones, PDAs, tablets, and similar devices.

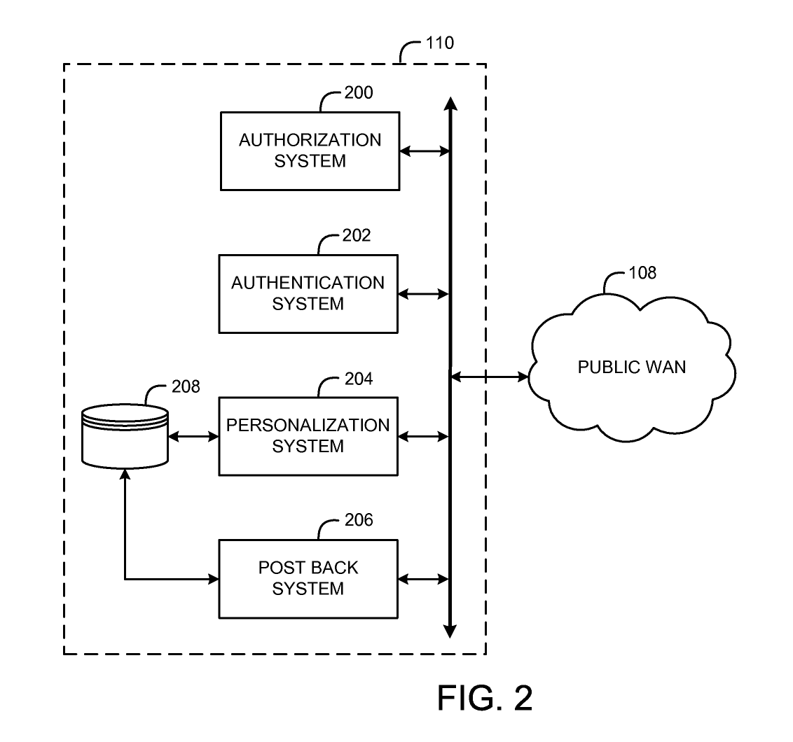

Lastly, a Service Enhancement System 110 is seen illustrated accessing the internet 108. The Service Enhancement System 110 may include a number of subsystems for enhancing a user's internet experience. FIG. 2 is a logical block diagram of the Service Enhancement System 110, in accordance with some embodiments. It can be seen that the Service Enhancement System 110 may include an Authorization System 200, an Authentication System 202, a Personalization System 204 and a Post Back System 206. The Personalization System 204 and Post Back System 206 may have access to a Storage 208 to further enhance the user's experience.

In some embodiments, the Authentication System 202 may be implemented separately from either of the Personalization System 204 or Post Back System 206. Likewise, the Personalization System 204 may be implemented without the Authentication System 202 and Post Back System 206 in some embodiments. In yet other embodiments, the Personalization System 204 may incorporate the functionality of the Post Back System 206, thereby obviating the need for separate systems. However, for the sake of brevity, an inclusive system is provided in the illustrated embodiments, with understanding that systems may be omitted or included as desired.

Each of the Authorization System 200, Authentication System 202, Personalization System 204 and Post Back System 206 may be capable of communication, in some embodiments, either directly, or through the internet 108. In some embodiments, the components of the Service Enhancement System 110 may be logical partitions on a single server system. In yet other embodiments, these components may be comprised of separate (or numerous) server systems working in a coordinated fashion.

Typically, the Authorization System 200 is decentralized and authorizes a user to access information streams in a distributed and granular fashion, as will be described in greater detail below. The Authentication System 202, in contract, is typically centralized, and enables centralized authentication of the user. The Personalization System 204 and Post Back System 206 may enable the population of documents from the Publishing Server 104a to 104n with personalized information, without sacrificing privacy, in a manner described in greater detail in the sections to follow.

### II. Granular Resource Access

The Internet started out as a de-centralized network with no single point of failure. In the past, websites hosted their own content, thereby having full ownership rights and control over it, and search engines like Google built indexes to all the content their web crawlers could access. More and more, however, users have been centralizing their data in the hands of a few companies. This phenomenon is most evident in the way that Facebook has gained control of the social lives of over 500 million people and the numerous privacy scandals that have arisen as a result. One major issue of these centralizations of data is how that data is shared. For example, if someone's Facebook friend wants to post photos online, they have to be a member of Facebook to see those photos. Otherwise, they are simply considered “everyone else” and denied access.

This form of sharing is both inadequate and inefficient. It requires too much of an investment on the part of the person who wants to view the photo (they have to go through an inconvenient sign-up process for Facebook) and not enough control for the person sharing the photo. More importantly, both parties are forced to hand over all their personal information to a single organization. Recent privacy concerns make it clear that people are very uncomfortable with all their information in the hands of a single entity.

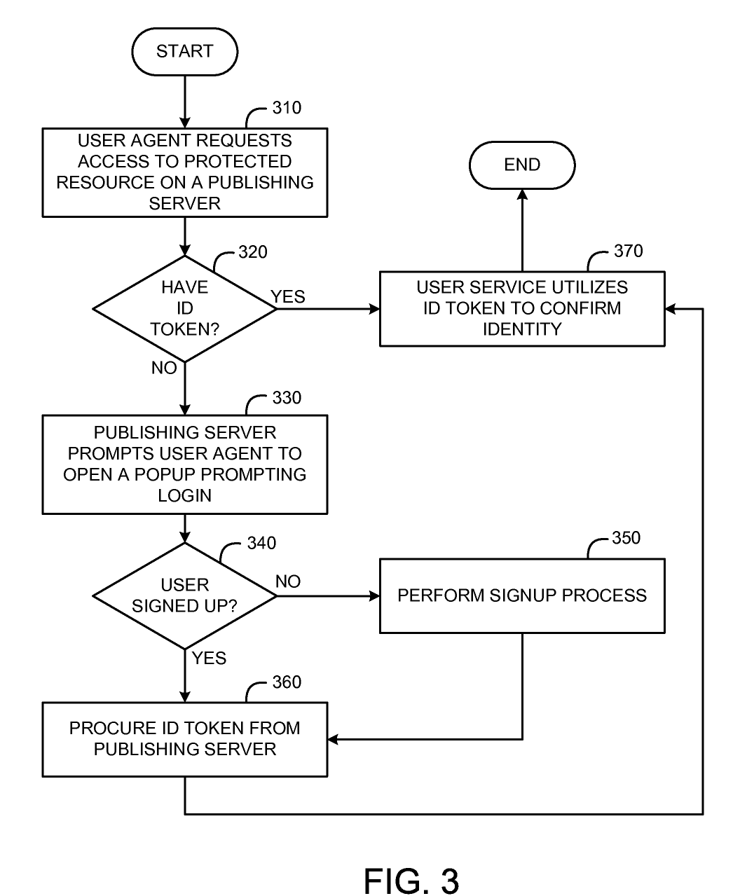

The root of the problem is that centralized social networks like Facebook were simply not designed for the variety of sharing that is now happening on a now, more mature, Internet. In FIG. 3 an example flow chart illustrates a method for allowing granular access to internet resources, in accordance with some embodiments. Embodiments of this method allow users to login to other servers on a network without entering in a different username and password for every server they encounter.

Embodiments of the method create unique credential for every server by applying a cryptographic hash function on the user's password, username (or other salt), and the URL of the server the user is attempting to access. This allows for a single-sign-on network where the user does not have to trust all the servers on the network. Salt, as is known in the art, is any number of random bits that is used as one of the inputs by the hashing function.

The methods provided also include protocols that prevent any server on the network from impersonating the user and accessing resources on their behalf. This keeps the user's personal information confidential from all servers even the authentication server. The user's Publishing Server 104a to 104n works like any other server on the network and requires all other users and servers to present the correct credentials to access resources.

In this method a user agent requests a protected resource from a web server using a User Agent 106 (at 310). A protected (or restricted) resource may include any data accessible via the web server that would not be accessible to any user of the internet. An example may include pictures on a Facebook private page for example. Next, an inquiry is made whether the User Agent 106 has an ID token for the restricted resource (at 320). The ID token is a user-publisher specific token that may be utilized to identify the user to the publisher. If the User Agent 106 has an ID token, the User Agent 106 may utilize the token to validate ID, and thus access the restricted resource (at 370). Embodiments of methods for accessing resources using an ID token will be provided in greater detail below.

Otherwise, if the User Agent 106 does not have the requisite token, then the web server prompts the User Agent 106 to open a login screen (at 330). This login screen may include a popup window for security purposes, in some embodiments. In such an embodiment, the web server may send the User Agent 106 a client-side script in order to open the popup. In response to the login window being displayed, a decision is made whether or not the user is signed up with the web server (at 340).

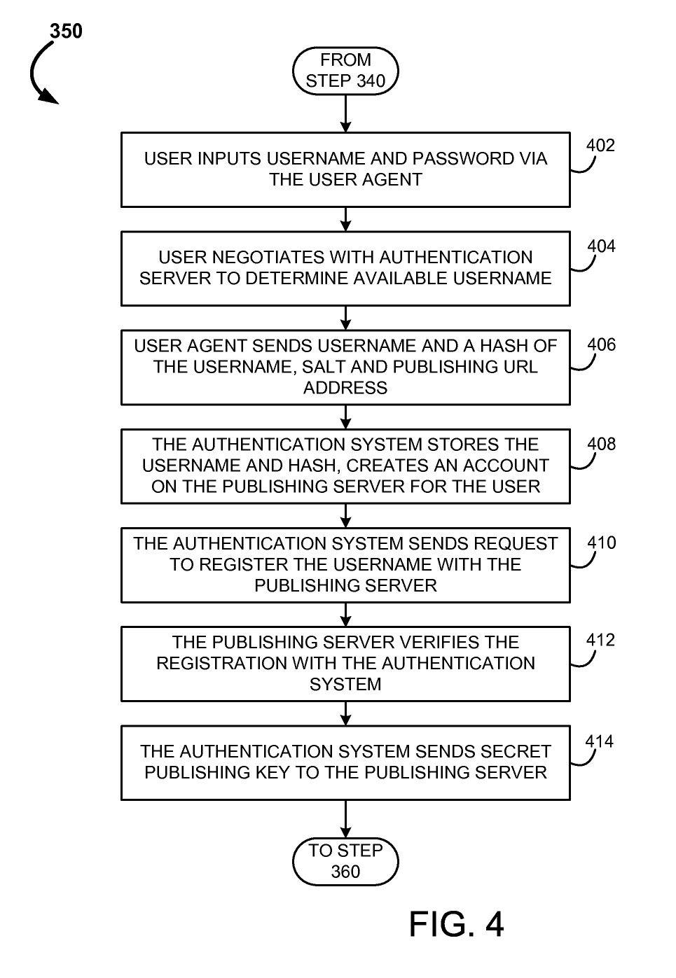

If the user is not currently signed-up, a signup process may be performed (at 350). Some example embodiment of the signup process is provided in relation to FIG. 4. In this example signup method, the user inputs a username and password, via the User Agent 106 (at 402). The User Agent 106 sends the username and a hash of the username, some form of salt, and the publishing server url address (or some portion thereof) to the Authentication System 202 (at 404). This is repeated until a valid username can be found. The Authentication System 202 stores the username and hash, and creates an account on the Publishing Server 104a to 104n for the user (at 406). The Authentication System 202 then sends a request to register the username with the Publishing Server 104a to 104n (at 408). The Publishing Server 104a to 104n verifies the registration with the Authentication System 202 (at 410), and the Authentication System 202 then sends a secret publishing key to the Publishing Server 104a to 104n (at 412). This ends the example signup process. The Publishing Server 104a to 104n may be hosted by the Authentication System 202 initially, and may later be hosted by another web server by installing the Publishing Server 104a to 104n on the web server.

Note, that the Authentication System 202 does not have any special access to the user's information which is stored securely on the user's Publishing Server 104a to 104n. The Authentication System 202 only knows the username and hash that is specific to it, and is merely meant to verify the user to other servers on the network. The Publishing Server 104a to 104n, the Authentication System 202 and any other server that the user has logged in to will all have a unique hash for the user.

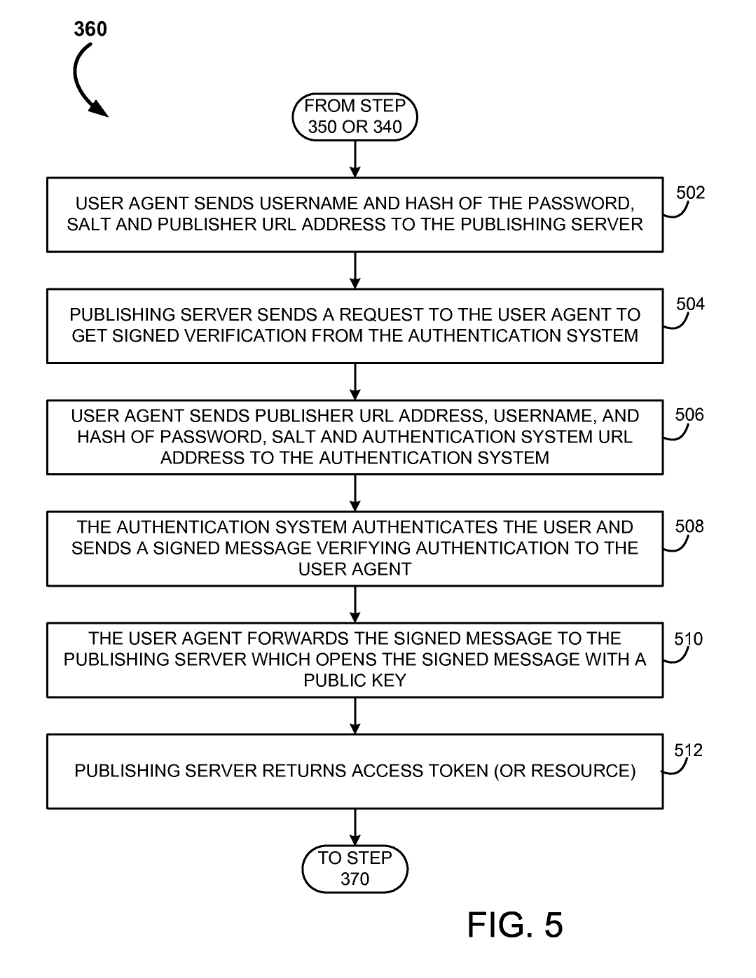

Returning to FIG. 3, after the signup process, or if the user was already signed up, a token is procured from the Publishing Server 104a to 104n (at 360). Some example embodiment of the token procurement process is provided in relation to FIG. 5. In this example process, the User Agent 106 sends the username and hash of the password, salt and publishing server url address (or some portion thereof) to the web server (at 502). Then the web server sends a request to the User Agent 106 to get signed verification from the Authentication System 202 (at 504); this step is to prevent web servers from impersonating a user. The User Agent 106 then sends the publisher url address, username, and a hash of the password, salt, and authentication system url address (or some portion thereof) to the Authentication System 202 (at 506). The Authentication System 202 may then authenticate the user (at 508), and sends a signed message verifying authentication to the User Agent 106. The User Agent 106 may then forward the signed message to the Publishing Server 104a to 104n (at 510) which opens the signed message with a public key. The Publishing Server 104a to 104n then returns the ID token, or the resource itself, in some embodiments (at 512). This ends the example token procurement process.

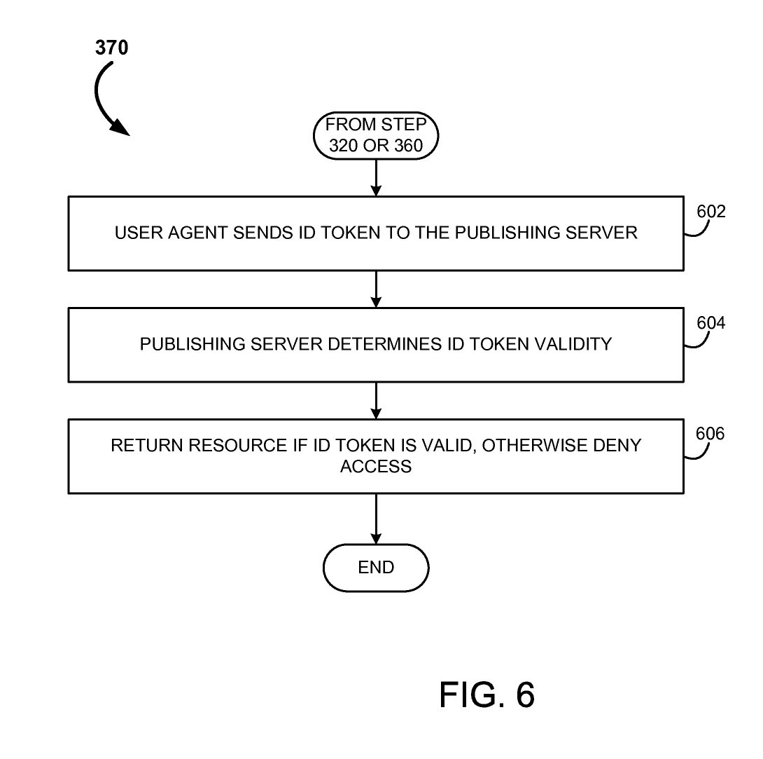

Returning to FIG. 3, after token procurement, the process the User Agent 106 utilizes the token to access the resource (at 370). Some example embodiment of accessing the resource utilizing the token is provided in relation to FIG. 6. In this example, the User Agent 106 sends the access token to the Publishing Server 104a to 104n (at 602). The Publishing Server 104a to 104n determines token validity (at 604), and returns the resource if the token is valid (at 606). If the token is not valid, access is denied. After the token is returned, the process ends until the user requests another protected resource from this, or some other Publishing Server 104a to 104n.

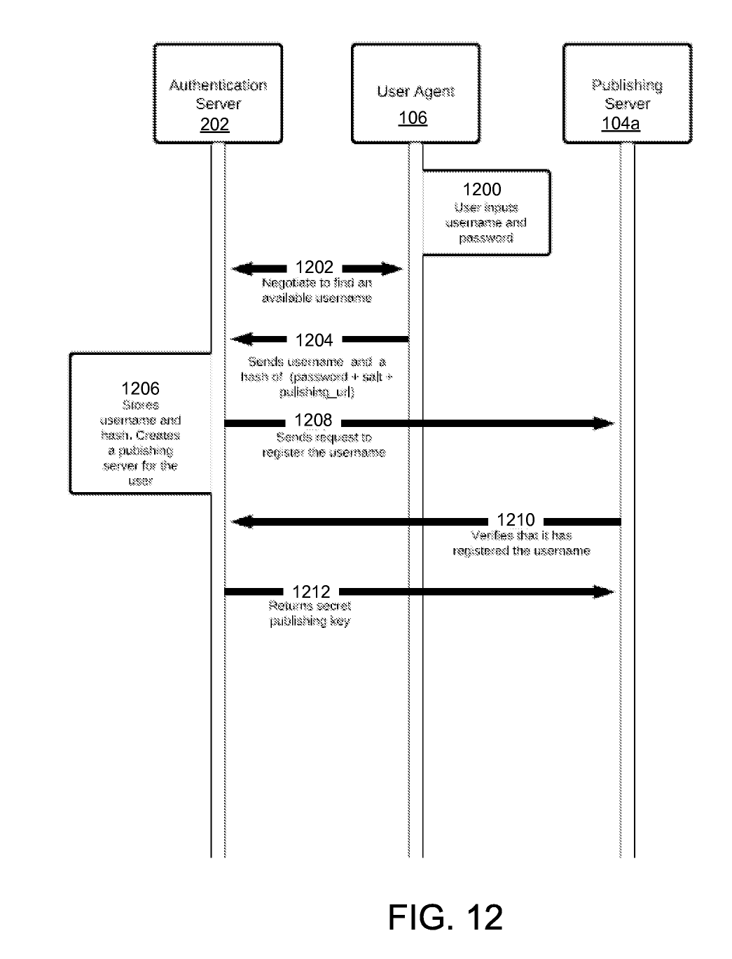

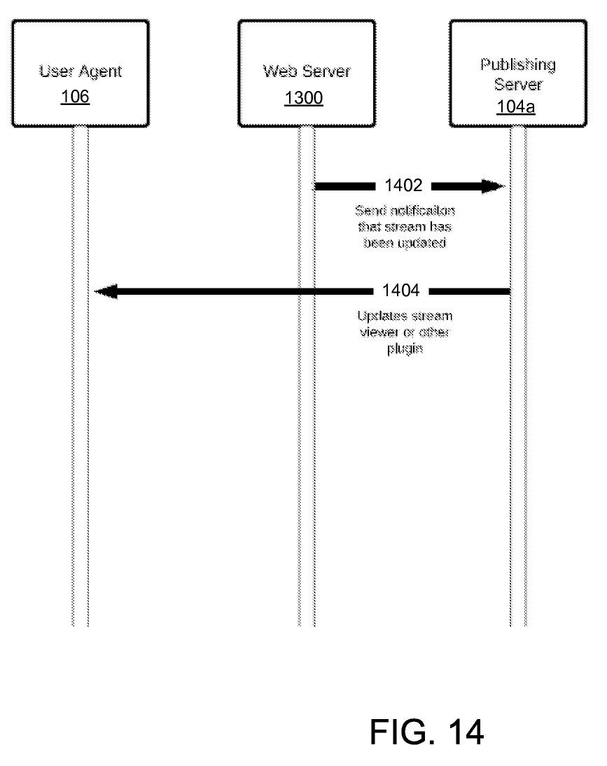

In addition, the process may be further visualized in example chronological processes diagramed in relation to FIGS. 12-15. In FIG. 12 an example chronological process diagram for the signup process is illustrated. Here the Authentication System/server 202, User Agent 106 and a Publishing Server 104a work in concert to generate a secret key. This process starts (at 1200) where the user inputs a username and password via the User Agent 106. The User Agent 106 and Authentication System/server 202 negotiate back and forth until an available username is determined (at 1202). Then the User Agent 106 sends the username and a hash consisting of the password, salt and some portion of the publisher url to the Authentication System/server 202 (at 1204).

The Authentication System/server 202 stores the username and hash (at 1206) and creates a publishing server for the user. The Authentication System/server 202 does this by sending a request to register the username with the Publishing Server 104a (at 1208). The Publishing Server 104a verifies that it has registered the username (at 1210). Lastly, the Authentication System/server 202 returns the secret publishing key (here the hash, however other secret keys can be utilized in some embodiments) to the Publishing Server 104a (at 1212).

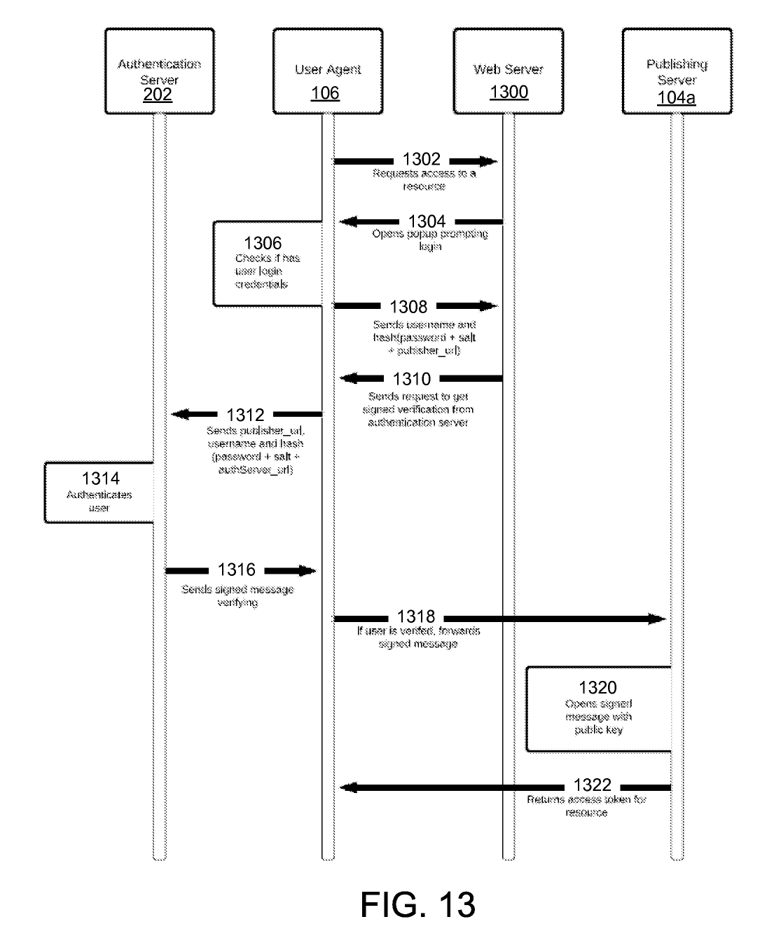

FIG. 13 illustrates an example chronological process diagram for user authentication. In this process, the Authentication System/server 202, User Agent 106, the Publishing Server 104a, and a web server 1300 work in concert to authenticate the user. Initially, the User Agent 106 requests access to a resource on the web server 1300 (at 1302), which then opens a popup prompting login on the User Agent 106 (at 1304). The User Agent 106 checks if it has user login credentials (at 1306) and sends the username and hash to the web server 1300 (at 1308).

The web server 1300 sends a request to the User Agent 106 to get signed verification from the Authentication System/server 202 (at 1310). The User Agent 106 sends the Authentication System/server 202 the publisher url, username and a hash of the password, salt and the authorization server's url (at 1312). The Authentication System/server 202 uses this information to authenticate the user (at 1314) and sends a signed message to the User Agent 106 verifying the authentication (at 1316). If the user is verified, the User Agent 106 forwards the signed message to the Publishing Server 104a (at 1318). Then the Publishing Server 104a opens the signed message with a public key (at 1320) and returns an ID token for the resource to the User Agent 106 (at 1322).

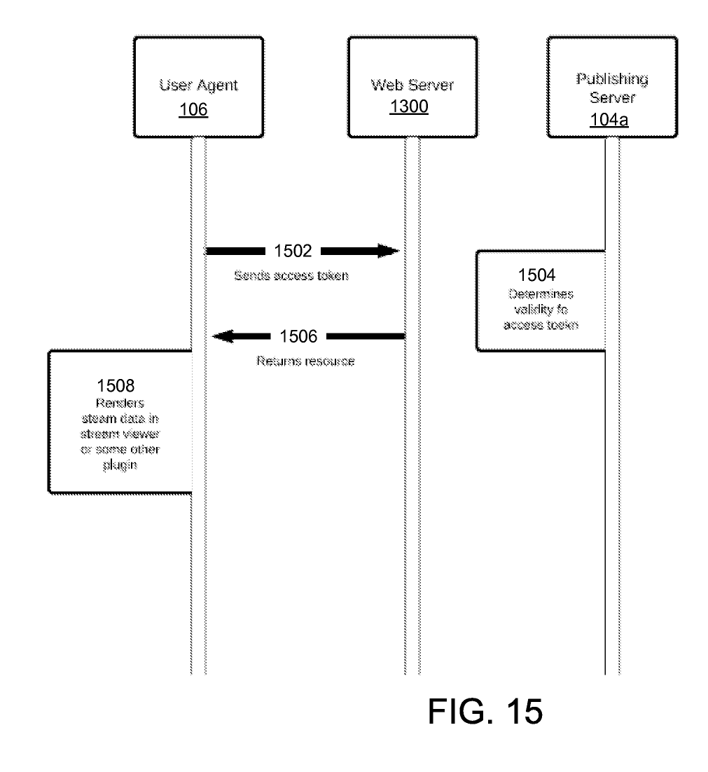

An example chronological process diagram for the resource access process is illustrated at FIG. 15. In this process, the User Agent 106 sends the ID token to the web server 1300 (at 1502). The Publishing Server 104a determines validity of the ID token (at 1504) and the web server 1300 then returns the resource to the User Agent 106 (at 1506). The User Agent 106 then renders stream data in a stream viewer or some other plug-in (at 1508).

As described above, in some embodiments, the resources may be converted into streams of information (streams) which have one or more of the following characteristics: a) the ability to carry a subscription state enabling the publishing server to allow, deny, or defer access to a resource; b) being able to receive updates; c) the ability to notify subscribers of changes to their chosen endpoint (e.g. email, mobile phone); and d) the ability to open a real-time connection to an endpoint such as a web browser using a web socket or comparable method.

A website owner can simply set some streams to public; allowing anyone to access them, and others to private; requiring authorization before access is granted. For example, if someone has a website that hosts their personal information, they can specify the subscription setting on the name and picture streams to be public, thereby allowing anyone access to this information, and meanwhile set those on the streams containing their phone number or pictures of their family, for example, to private; requiring permission before someone can see them.

As intended, streaming has particular usefulness in the field of online social networking, as it does not rely on the ambiguous and generalized status of “friend” as the main determining factor for who can access a resource; streaming allows for more precise control.

Additionally, in some cases, where streams are updated the publishing server 104a may send a notification to the user according to the stream configuration and the user's preferences. Such an example chronological process diagram for stream update notification may be seen at FIG. 15. When a stream owner updates a stream, all subscribers will be alerted of the changes, in some embodiments. For example, if website owner in the previous example were to change their phone number, all the subscribers would be alerted of the person's new number. In this process, the web server 1300 sends a notification to the Publishing Server 104a that a stream has been updated (at 1402). Then the Publishing Server 104a updates the stream viewer or plug-in with the User Agent 106 (at 1404).

In some embodiments, the “stream viewer” can be used to display the data of streams that the user is subscribed to; in real-time or with delay. The stream viewer can potentially even take the place of an email inbox because users can receive messages without unwanted notifications or spam. For example, if a stream starts to “act up” and become annoying to the user, that person can simply unsubscribe. Conversely, if a stream is very useful, the user can syndicate it to their mobile phone or other destination.

Developers are also able to create plug-ins for the stream viewer that can manage and display stream data inventive ways. In this way, the stream viewer has the potential to become much more powerful than standard inboxes which are usually completely controlled by the email service provider.

In some embodiments, users can subscribe to streams using buttons that group one or more streams together. For example, the website owner might create a button saying “My Contact Information” that, when clicked, automatically subscribes the user to the owner's phone numbers, email address and home address streams.

When a protected resource is accessed, it may or may not contain the actual data of the update to the stream. If it does not contain the data, the client may be able to go and request the updated data from the server for that particular stream, in some embodiments.

### III. Personalization

As previously discussed, personalization of internet content provide a user with a more appealing web surfing experience. For content providers, having rich websites that are “social” and personalized increases its popularity (and therefore revenue). Described herein are processes and methods that allow publishers of websites on the internet, mobile phones, and other media, to embed and display personalized information for a user that is visiting their documents.

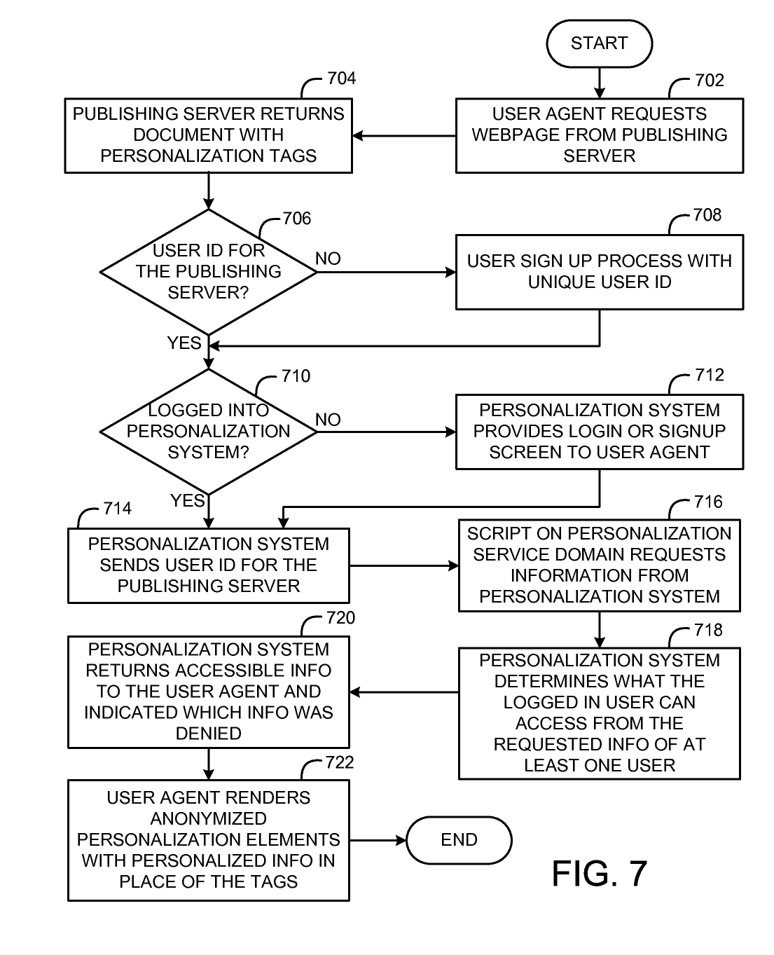

FIG. 7 is an example flow chart illustrating a method for personalizing a document while maintaining maximal privacy, in accordance with some embodiments. In this example flowchart, the User Agent 106 may request a webpage from the Publishing Server 104a to 104n (at 702). This request may include a cookie with session ID, in some embodiments. The Publishing Server 104a to 104n then returns a document with personalization tags embedded within the document (at 704). This document may, in some embodiments, be HTML code containing special tags that stand for personalized information, for example. These personalization tags request personal information regarding the user to be filled in by the Personalization System 204.

Next, an inquiry is made whether the User Agent 106 has a valid user ID for the Publishing Server 104a to 104n (at 706). If the User Agent 106 does not have a valid user ID, the user may undergo a signup process (at 708). In some embodiments, the signup process for a user ID may substantially reflect the process exemplified at FIG. 4, as disclosed previously.

Once the user has signed up (or if the user already has a unique user ID for the Publishing Server 104a to 104n), then an inquiry may be made as to whether the user is logged into the Personalization System 204 (at 710). If the user is not yet logged into the Personalization System 204, a login or signup screen for the Personalization System 204 may be opened utilizing the User Agent 106 (at 712). The signup/login screen may, in some embodiments, be a popup in order to enhance security. The user may then signup with the Personalization System 204 or login if they are already signed up.

After logging in, the Personalization System 204 sends a user ID to the Publishing Server 104a to 104n (at 714). A script on the personalization service domain then requests information from the Personalization System 204 (at 716). In some embodiments, this information may be stored, as will be described in greater detail below. The Personalization System 204 reviews the information request and determines what the logged in user can access (at 718). The Personalization System 204 then returns accessible information to the User Agent 106 (at 720) and also indicates what information is denied. This return may include the input HTML with the personalization tags replaced by text or widgets, in some embodiments. The User Agent 106 may then render an iframe of the updated document (at 722). In some embodiments, instead of rendering the iframe, the output may consist of the raw input HTML code with special tags replaced with personalized text or widgets. The advantage of wrapping the document in an iframe is that the Publishing Server 104a to 104n can display the information but not access it, thereby increasing the user's privacy.

Note, that for the purposes of this document, an iframe is defined as an element in web browsers which is able to display information from a different internet domain, without allowing front-end scripting on the containing document to get access to it. This may also cover frames, and other elements which may hold information not accessible to front-end scripting. As a generic class, these may be referred to as anonymizing personalization elements.

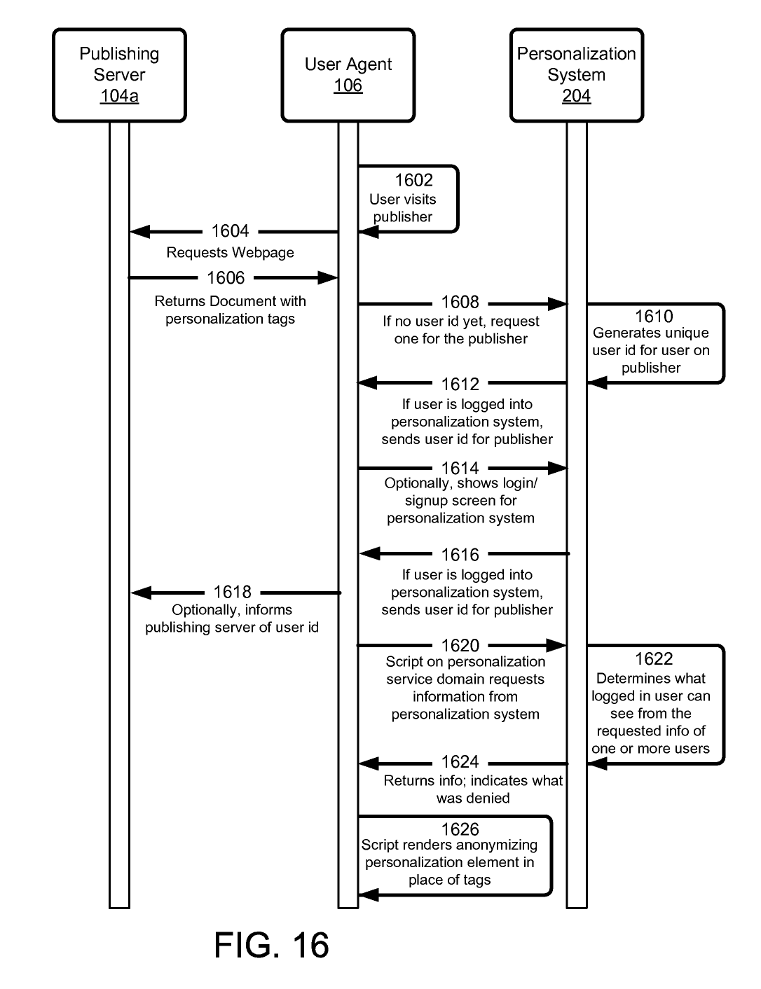

FIG. 16 provides an example chronological process diagram for the anonymous personalization, in order to further illustrate embodiments. In this chronological diagram, a Publishing Server 104a, the User Agent 106 and the Personalization System 204 act in concert to personalize a webpage. First, the User Agent 106 visits the publisher (at 1602) by requesting a webpage from the Publishing Server 104a (at 1604). The Publishing Server 104a returns a document to the User Agent 106 (at 1606), which includes personalization tags.

If no user ID exists yet, the User Agent 106 utilizes the Personalization System 204 to request a user ID from the publisher (at 1608). The Personalization System 204 generates a unique user ID for the user on the publisher (at 1610).

Next, if the user is logged into the Personalization System 204, the user ID is sent from the Personalization System 204 to the User Agent 106 (at 1612). Otherwise, a login signup screen for the Personalization System 204 is provided, thereby enabling the user to login (at 1614). After login, the user ID is sent from the Personalization System 204 to the User Agent 106 (at 1616).

The User Agent 106 may then optionally inform the Publishing Server 104a of the user ID (at 1618). A script (may be a JavaScript) on the personalization service domain requests information from the Personalization System 204 (at 1620). The Personalization System 204 determines what the logged in user is enabled to view from the requested information of one or more users (at 1622), and returns the information to the User Agent 106, and indicating what information was denied (at 1624). The User Agent 106 then renders anonymizing personalization elements in place of the tags in the document (at 1626).

An example of this process includes a scenario where a forum has various posts done by certain visitors. The publisher of the forum may want to display the post together with the avatar (icon, display name, etc.) of the user who posted it. When clicking or tapping that avatar, we may want a mini-profile to show up, showing further information about that user. All this should be personalized to the visitor browsing the forum, but the publisher should not have access to the user's personalized information, because it is displayed in an iframe. The publisher sends a request to the Personalization System 204, with an entire paragraph that may contain some personalized info. The result is one or more iframes that contain what the paragraph contained, with the requested personalization tags replaced with personal information. The publisher can now display this iframe in place of the paragraph.

In some embodiments, the information supplied to the Personalization System 204 may be stored (as a cached resource, or on the Storage 208, in some embodiments). By storing this information, the User Agent 106 can subsequently populate other documents with the information, thereby reducing the need to constantly request data from the Personalization System 204. The determination of what information should go in the iframe can be done in a number of ways, for example using the name of the iframe. For example, assume a group of people have signed up with freemeet.com, and it operates a personalization service. A publisher has included freemeet.com's personalization javascript in their document. When invoked, that javascript parses the HTML to find tags of the form <fm:ml>stuff here</fm:ml> where the stuff here can include, for example <fm:name firstnameonly=‘true’ user_id=“29387”></fm:name> talked to <fm:name firstnameonly=‘true’ user_id=“29112”></fm:name>. In this example, the publisher may get back HTML of the form <iframe . . . > talked to <iframe . . . >. When this is inserted into the document, the iframes go to work and populate themselves with the correct information, without having to make any further requests to the personalization service.

In yet another embodiment, the publisher may call a Personalization System 204 that returns HTML with iframes that make use of it and one or more other personalization services. In this manner, the user can keep their information on various different services and combine them in a mash-up, while none of the services or the publisher can access information returned by the other services. Note that the Personalization System 204 may be a single service, or a distributed group of services. In some embodiments, the personalization system/service(s) may be hosted by a publisher web server, may be locally hosted, or centrally hosted (as illustrated in example FIG. 2).

In addition to the process described above, the publisher of the document can invoke a client-side mechanism (such as calling a script or instantiating an iframe) that will obtain the user's identity with the Personalization System 204. This identity may be in the form of a user id for the Personalization System 204, which allows the document to appear with the personalized information already embedded, without the user having had to do anything besides request the document.

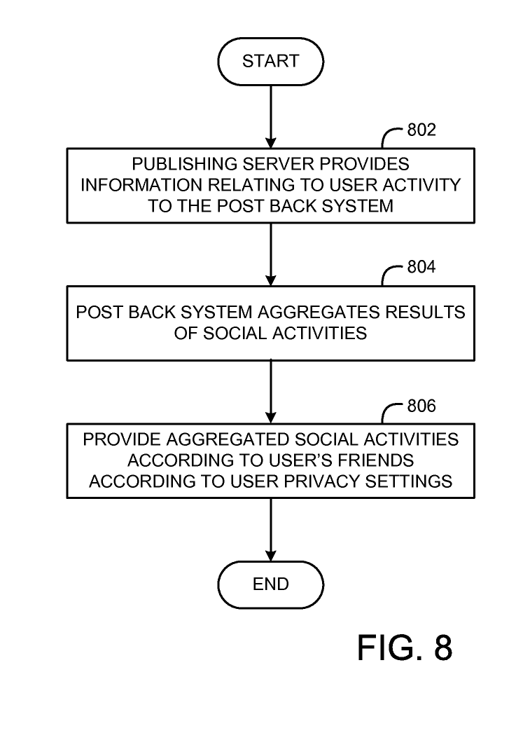

In addition to the personalization performed via the Personalization System 204 outlined above, it is possible for some embodiments to include a “post back” functionality to further increase personalization. FIG. 8 is an example flow chart illustrating a method for enhancing personalization via a post back system, in accordance with some embodiments. In this example process, the Publishing Server 104a to 104n provides information relating to the user activity to the Post Back System 206 (at 802). As previously mentioned, the Post Back System 206 may be its own independent system, or its functionality may be merged into the Personalization System 204. The Post Back System 206 may then aggregate results of social activities from the user from this post back and other publishers' post backs (at 804). This aggregate of activity information may then be made accessible to the user's friends according to the privacy settings of the user (at 806).

An example for this kind of “post back” activity is as follows: a user goes to NYTimes.com and is able to see the actions that their friends have taken on the site using the site's own commenting system. That is, NY Times did not have to use a centralized commenting system, and yet a visitor is able to see what his/her friends have done on the site, due to the fact that NY Times has reported their activity via the post-back service.

As before, the user ID for the Publishing Server 104a to 104n may be unique for each Publishing Server 104a to 104n in order to prevent user tracking across domains. A unique user ID may be generated in a number of ways, including:
a) generating a unique sessid on the back end of the instant personalization service for a (publisher, visitor_user_id) pair, using it plus the publisher to look up the visitor_user_id during requests;
b) the same as above but where the unique sessid is a hash of (publisher+visitor_user_id+salt); or
c) encrypting (publisher+visitor_user_id+salt) using the user's public key.

An example of this would include where a user is able to visit several different internet sites, and on each site they are able to instantly have an account, see the activity of their friends on that site, and much more. However, no one is able to track the user across different domains except their own personalization service, which they presumably trust. This is much superior to the techniques that have been used up until now, such as “session secrets” and other workarounds to data hijacking and impersonation. Additionally, with this disclosed methodology, a user no longer has to authorize the use of their personal data merely for display purposes (e.g., using OAuth) when a site requests access to some of the user's personal data.

Further, the granular resource access systems and methods outlined above may be utilized in concert with the personalization methods in order to enable users to have a choice of where they wish to host their personal data. They don't have to necessarily trust Facebook, Google or any other service to store their data in order to have a personalized experience on the internet. They are free to host the data themselves using any arrangement they trust (such as a hosting service or their own computer). As detailed above, a Publishing Server 104a to 104n may be authorized to access personal (i.e., consume one or more data streams). The user ID can be provided by the user's preferred server, in a similar way to how login is described above:
a) The Publishing Server 104a to 104n includes an iframe or script pointing to a centralized Authentication System 202, or, if the user has already logged into the Personalization System via the User Agent, the iframe may point straight to a resource on that domain.
b) When a user first visits the Publishing Server 104a to 104n, the central Authentication System 202 refers a User Agent 106 to the user's preferred hosting service (Web Server), which hosts the user's Authorization System 200 and/or Personalization System 204.
c) The user's preferred hosting service then gives out the user ID for that publisher to use. Typically, that user ID would be prefixed something like the url of the hosting service, or hash (main_user_publisher_url+main_user_id+main_user_salt) where main_user_id is the user's ID in the central Authentication System 202. This is so there are no clashes between user IDs.
d) The publisher can then use this user ID with the Personalization System 204 and Post Back System 206 hosted on the user's preferred hosting service, by the user, or centrally hosted.

Conversely, in some alternate embodiments, the personalization described above may be implemented instead with distributed authorization and authentication. In such embodiments, the publisher loads a static iframe or javascript from some constant URL. This URL would be a static script from some central source, but it is heavily cached. The static script is configured to look at information on the local machine (such as in local storage, or window.name, or anything else that is desirable) which need not be domain-specific, and discover all the compatible services that the user has authenticated with. The publisher can then use one of them to authenticate, and then personalization can ensue as detailed above.

### IV. Login Method

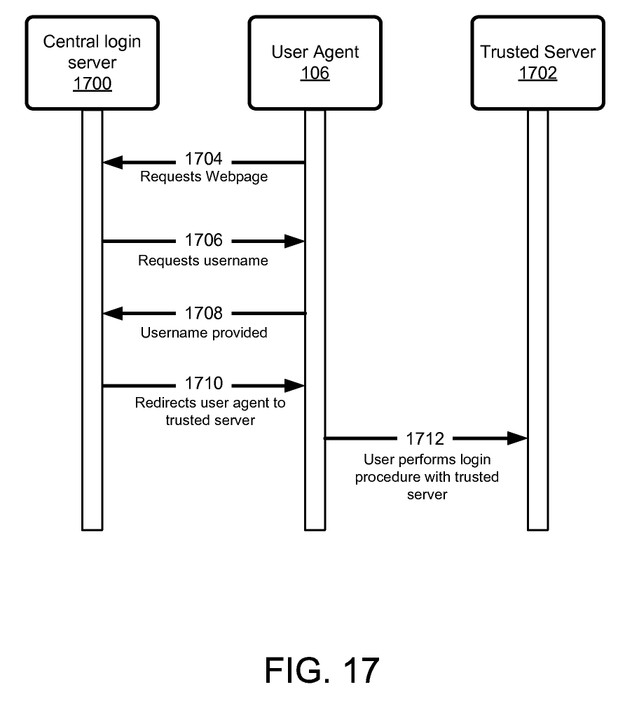

FIG. 17 is an example chronological process diagram for logging in a user, in accordance with some embodiments. This unique login process enables a user to visit virtually any website that employs this method, and immediately be directed to the user's trusted server for login. This method acts independent of cookies or other tracking software, thereby enabling a user to reduce his reliance on these sorts of mechanisms.

In this example login, a User Agent 106 may visit a central login server 1700, which may be the Authentication Server 202, in some embodiments, or may be some other centralized login system. The user requests a webpage from the central login server 1700 (at 1704), and the central login server 1700 may request the user input a username or other identifier (at 1706).

The user may provide the username (at 1708) and the central login server 1700 may reference the user's preferences using this data. The central login server 1700 may then identify a trusted server 1702 for the user which is preferred by the user for login purposes, and where they may host and authorize their streams. The trusted server 1702 may be a publishing server 104a (like Facebook) or a local server. The central login server 1700 may then direct the user to the trusted server 1702 (at 1710). This may include a redirect, opening a popup or other browsing window, iframe, or other means of displaying the login screen from the trusted server's domain. The user may then perform the login process with his preferred trusted server 1702 (at 1712).

### V. Examples

In order to better illustrate the functionality of the personalization systems and methods disclosed herein, a number of exemplary screen shots are provided. These screen shots are intended to be entirely for clarification purposes, and by necessity only provide examples of some of the functionality disclosed above. In no way should these example screenshots be construed as limiting to the scope of the disclosure.

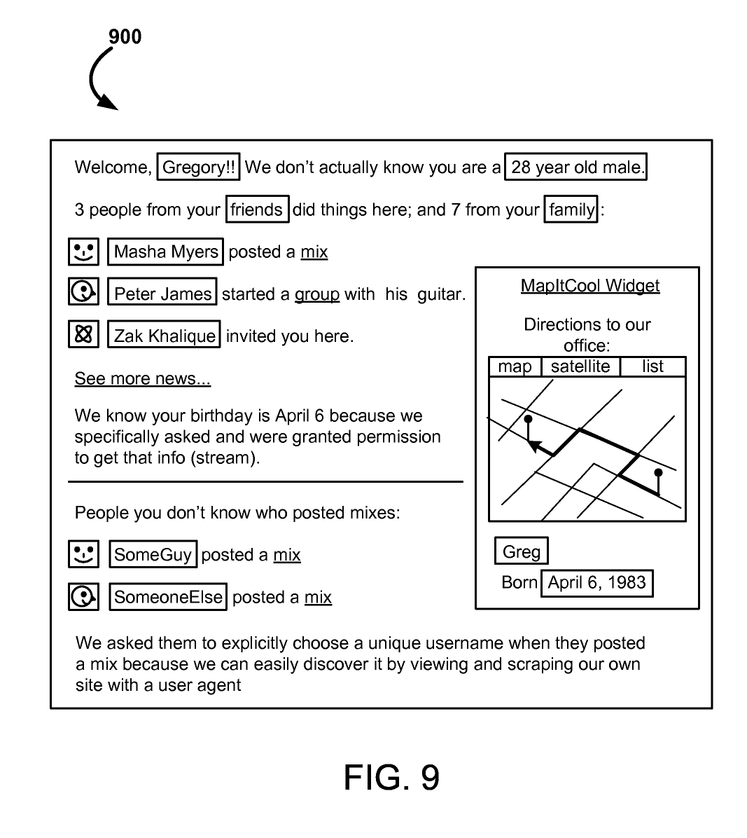

FIG. 9 is an example screen shot illustration of a personalized document, shown generally at 900, in accordance with some embodiments. In this example website display, a number of text elements are surrounded by boxes. These boxed text may be personalized information that has been populated in a manner consistent with the process outlined in FIG. 7.

In this example, the user's name (here “Gregory”) and age/gender, friends and family, in this example, may have been collected from the Personalization System 204. User IDs that are unique to the Publishing Server 104a to 104n are issued, in this example, by a centralized Authentication System 202. A fourth party widget (here the “Map it Cool Widget”) explicitly asked for, and was granted, access to the user's address, but is denied access to your name and birthday. However, due to the nature of the iframes, this data may still be displayed on the widget, in this example.

The information regarding people the user does not know is not generated vie the personalization system, and thus can be displayed for the user even when he is logged-out of their Personalization System 204.

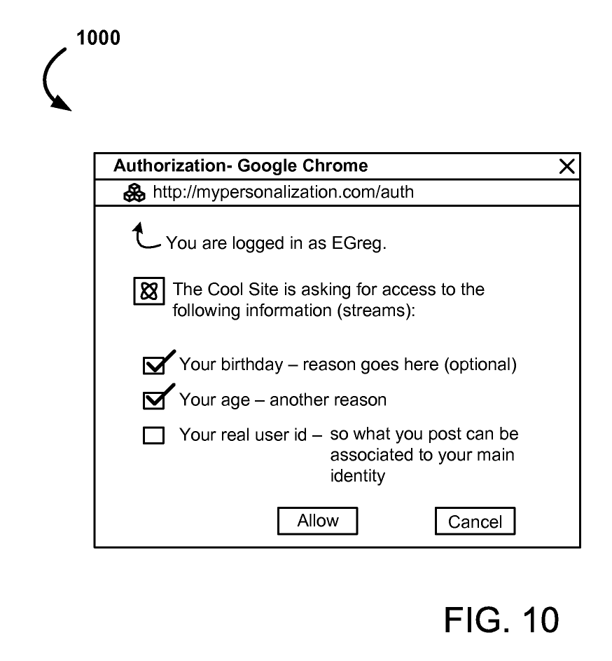

Additionally, FIG. 10 is an example screen shot illustration of an authorization screen, shown generally at 1000, in accordance with some embodiments. In this example screenshot, the authorization screen is displayed as a popup for security and to prevent spoofing. A url is displayed for security as well. In this example, the user has granted “the Cool Site” access to the user's birthday and age, but not their real ID. Granting the user's real ID removes the anonymity the user enjoys among everyone the user did not grant access to see their ID (such as “friends”). In this example, the user has selected to deny the public access to their identity.

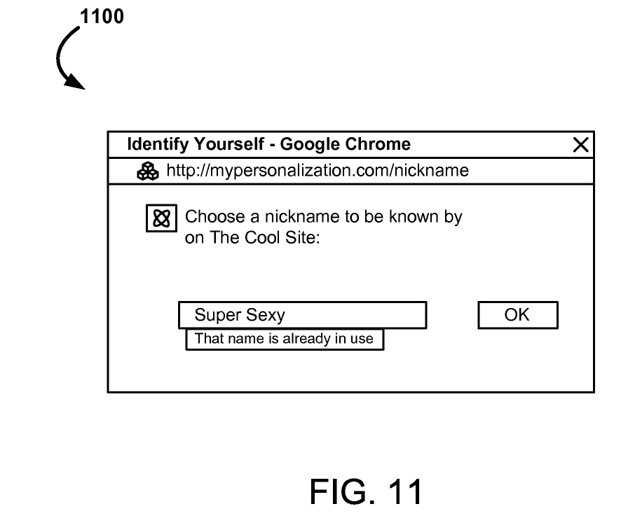

Further, FIG. 11 is an example screen shot illustration of an identification screen, shown generally at 1100, in accordance with some embodiments. In this example, a popup is again utilized to prevent spoofing, and a url is displayed for added security. The user is able to input a nickname into the identification field (here “super sexy” was chosen) which functions to preserve the user's anonymity among non-trusted users (i.e., non-friends). Thus, the user may be represented by the publisher by a standard tag, or by the user's real name, dependent upon how much access the viewer is entitled to. In this example, the nickname “super sexy” has been determined to already be claimed, and as such another nickname is required to be chosen.

In sum, the present invention provides systems and methods for personalizing web sites without compromising privacy. Such systems and methods include the usage of a personalization system alone or in combination with centralized authentication to provide advanced web viewing experiences.

While this invention has been described in terms of several embodiments, there are alterations, modifications, permutations, and substitute equivalents, which fall within the scope of this invention. For example, while the publishing server is illustrated as being centrally hosted, in some embodiments the user may locally host one or more publishing server, or individual websites may host a publishing server, respectively.

It should also be noted that there are many alternative ways of implementing the methods and systems of the present invention. It is therefore intended that the following appended claims be interpreted as including all such alterations, modifications, permutations, and substitute equivalents as fall within the true spirit and scope of the present invention.

What is claimed is:

1) A method for anonymously personalizing web content to a particular user, useful in association with a personalization system, the method comprising:
listening for requests including code and tags that stand for personalized information;
masking personal information for a user corresponding to the tags of the request, wherein the masking generates anonymized personalization elements, wherein the anonymized personalization elements are at least one element in a web browser which is enabled to display the personal information from a different domain without allowing front-end scripting on the containing document to get access to the personal information; and
returning an output, wherein the output includes the tags replaced by the anonymized personalization elements.

2) The method as recited in claim 1, further comprising:
caching the anonymized personalization elements;
showing the anonymized personalization elements; and
executing a client side script to populate the anonymized personalization elements with information appropriate to the anonymized personalization elements.

3) The method as recited in claim 1, further comprising obtaining an identity for the user.

4) The method as recited in claim 2, further comprising obtaining an identity for the user.

5) The method as recited in claim 3, wherein the user has unique identities for each publisher.

6) The method as recited in claim 4, wherein the user has unique identities for each publisher.

7) The method as recited in claim 1, wherein the anonymized personalization elements include at least one iframe.

8) The method as recited in claim 2, wherein the caching includes storing the anonymized personalization elements on client side local storage.

9) The method as recited in claim 1, further comprising embedding a widget into at least one of the anonymized personalization elements.

10) The method as recited in claim 1, further comprising receiving post back information from the publishing server, wherein the post back information is aggregated with other information, and the aggregated information is displayed to friends of the user based upon the user's privacy settings.

11) A method for personalizing web content while preserving a user's privacy, useful in association with a publishing server, the method comprising:
loading a static script from a constant URL, wherein the static script is configured to look for information on a local computer and discover compatible services that a user has authenticated with it;
receiving a request for a webpage from a user agent;
providing the static script to the user agent;
receiving feedback from the static script;
authenticating with the compatible service identified in the feedback;
returning a document with personalization tags to the user agent; and
receiving an output with anonymized personalization elements, wherein the anonymized personalization elements are at least one element in a web browser which is enabled to display information from a different domain without allowing front-end scripting on the containing document to get access to the information.

12) A method for logging a user into a system comprising:
displaying a login screen to a user from a centralized login server;
receiving a username from the user;
matching the username to a corresponding personal server different from the centralized login server; and
redirecting the user to the personal server.

13) The method as recited in claim 12, wherein the personal server is an authentication system.

14) The method as recited in claim 12, wherein the personal server is a personalization system.

15) A personalization system configured to anonymously personalize web content to a particular user, the system comprising:
a monitor configured to listen for requests including code and tags that stand for personalized information;
an anonymizer configured to mask personal information for a user corresponding to the tags of the request, wherein the masking generates anonymized personalization elements, wherein the anonymized personalization elements are at least one element in a web browser which is enabled to display the personal information from a different domain without allowing front-end scripting on the containing document to get access to the personal information; and
a deliverer configured to return an output, wherein the output includes the tags replaced by the anonymized personalization elements.

16) The system as recited in claim 15, further comprising:
storage configured to cache the anonymized personalization elements;
an examiner configured to show the anonymized personalization elements; and
a processor configured to executing a client side script to populate the anonymized personalization elements with information appropriate to the anonymized personalization elements.

17) The system as recited in claim 15, further comprising an authentication system configured to obtain an identity for the user.

18) The system as recited in claim 16, further comprising an authentication system configured to obtain an identity for the user.

19) The system as recited in claim 17, wherein the user has unique identities for each publisher.

20) The system as recited in claim 18, wherein the user has unique identities for each publisher.

21) The system as recited in claim 15, wherein the anonymized personalization elements include at least one iframe.

22) The system as recited in claim 16, wherein the caching includes storing the anonymized personalization elements on client side local storage.

23) The system as recited in claim 15, further comprising a post back system configured to receive post back information from the publishing server, wherein the post back information is aggregated with other information, and the aggregated information is displayed to friends of the user based upon the user's privacy settings.
